(19) United States
(12) Patent Application Publication
(10) Pub. No.: US 2012/0297834 A1
(43) Pub. Date: Nov. 29, 2012

(54) MULTI-STAGE GLASS PRESSING SYSTEMS AND METHODS

(75) Inventors: David V. King, Gibsonia, PA (US); David T. Perry, Poseyville, IN (US); Kurt Steinbacher, Evansville, IN (US)

(73) Assignee: Pittsburgh Glass Works, LLC, Pittsburgh, PA (US)

(21) Appl. No.: 13/117,245

(22) Filed: May 27, 2011

(51) Int. Cl. C03B 23/03; C03B 11/05

(52) U.S. Cl. 65/104; 65/286; 65/106

(57) ABSTRACT

An apparatus for shaping at least one glass sheet. The apparatus includes a lower press ring and an upper press ring configured to clamp a perimeter section of the glass sheet between the lower press ring and the upper press ring. The apparatus also includes an upper press at least partially disposed within the upper press ring, the upper press configured to shape at least a section of the glass sheet inside the perimeter section of the glass sheet.

### BACKGROUND

Vehicle glass panels, such as windshields and windscreens, are usually laminated structures that include two layers of glass that are bound together by a thermoplastic material, such as vinyl. Flat sheets of glass (e.g., float glass) that are larger than the desired size of the laminated structure are cut to size to create inner and outer glass plies. The edges of the glass plies are ground, the plies are washed, and a ceramic paint is often applied to a portion or portions of one or both of the plies. The plies are heated and shaped, either one ply at a time (i.e., a singlet process) or at the same time with both plies stacked (i.e., a doublet process). The shaping process is accomplished by pressing the plies into their final form using a press tool. Generally, a lower press ring lifts the plies and presses them on to a top press to achieve the desired shape and dimensional characteristics. A thermoplastic material layer or layers are inserted between the plies and the laminated structure is heated in an autoclave such that the desired clarity and visual characteristics of the laminated structure are achieved.

Vehicle manufacturers often design vehicle glass panels that utilize glass having curves of smaller radii to improve wiperability, reduce weight, improve the vehicle's aerodynamic properties, lower the vehicle's profile, etc. In forming such curves, the forming process must be designed such that the glass is not overstressed to the point that the glass breaks or buckles, thus creating optical and reflective distortion (i.e., a lens effect). However, current manufacturing techniques often result in such deleterious effects. When a lower ring pushes the glass from the outside perimeter over the press shape, stress levels form that are sufficient to cause localized buckling around the perimeter of the glass. Such buckling is a function of the glass thickness, the depth of the required bend in the glass, and the length of time that the glass is allowed to bend during the forming process.

Thus, there is a need for glass panel manufacturing processes and equipment that allows for glass panels to be formed while minimizing the negative effects of bending the glass.

### SUMMARY

Various embodiments of the present invention are directed to an apparatus for shaping at least one glass sheet. The apparatus includes a lower press ring and an upper press ring configured to clamp a perimeter section of the glass sheet between the lower press ring and the upper press ring. The apparatus also includes an upper press at least partially disposed within the upper press ring, the upper press configured to shape at least a section of the glass sheet inside the perimeter section of the glass sheet.

Various embodiments of the present invention are directed to a system for shaping at least one glass sheet. The system includes a lower press ring and an upper press assembly. The upper press assembly includes an upper press ring configured to clamp a perimeter section of the glass sheet between the lower press ring and the upper press ring, and an upper press at least partially disposed within the upper press ring, the upper press configured to shape at least a section of the glass sheet inside the perimeter section of the glass sheet. The system further includes a press positioning assembly that is configured to raise and lower the upper press within the upper press ring.

Various embodiments of the present invention are directed to an apparatus for shaping at least one glass sheet. The apparatus includes means for clamping a perimeter section of the glass sheet, and means for shaping at least a section of the glass sheet inside the perimeter section of the glass sheet.

Various embodiments of the present invention are directed to a method for shaping at least one glass sheet. The method includes clamping a perimeter section of the glass sheet between a lower press ring and an upper press ring, and shaping at least a section of the glass sheet inside the perimeter section of the glass sheet using a movable upper press that is disposed within the upper press ring.

Those and other details, objects, and advantages of the present invention will become better understood or apparent from the following description and drawings showing embodiments thereof.

### BRIEF DESCRIPTION OF THE DRAWINGS

Various embodiments of the present invention are described herein by way of example in conjunction with the following figures, wherein:

FIGS. 1 and 2 illustrate successive steps in a prior art glass panel fabrication process;

FIGS. 3-5 illustrate successive steps in a glass panel fabrication process in accordance with various embodiments of the present invention;

FIG. 6 illustrates a perspective view of a glass press assembly that incorporates various elements of FIGS. 3-5 according to various embodiments of the present invention;

FIG. 7 illustrates a top perspective view of the upper press ring and the upper press according to various embodiments of the present invention; and

FIG. 8 illustrates a top perspective view of the upper press according to various embodiments of the present invention.

### DESCRIPTION

Embodiments of the present invention are directed to a multi-stage glass panel manufacturing process in which the perimeter of at least one glass sheet that comprises the glass panel is clamped to a final dimensional profile. The center of the glass sheet is then pressed out to achieve the desired dimension and shape of the glass. Such a process minimizes compressive stress, reduces thin film buckling, and reduces optical distortion. In various embodiments, the present invention may be used to shape single glass sheets (i.e., singlets), double glass sheets (i.e., doublets), or any other multiple of glass sheets.

As used herein, spatial or directional terms, such as “inner,” “outer,” “left,” “right,” “up,” “down,” “horizontal,” “vertical,” “upper,” “lower,” and the like, relate to the invention as it is shown in the figures. However, it is to be understood that embodiments of the present invention can assume various alternative orientations and, accordingly, such terms are not to be considered as limiting. Further, all numbers expressing dimensions, physical characteristics, and so forth, used in the specification and claims are to be understood as being modified in all instances by the term “about.” Accordingly, unless indicated to the contrary, the numerical values set forth in the following specification and claims can vary depending upon the desired properties sought to be obtained by embodiments of the present invention. Moreover, all ranges disclosed herein are to be understood to encompass any and all subranges subsumed therein. Also, as used herein, terms such as “positioned on,” “into contact with” or “supported on” mean positioned or supported on but not necessarily in direct surface contact with.

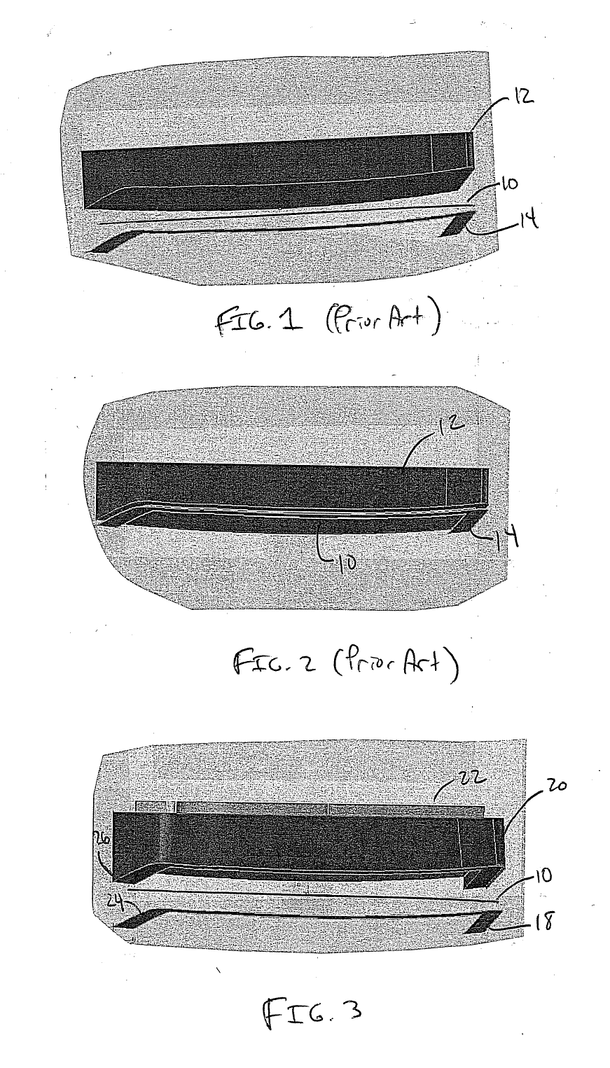

In a glass fabrication process, glass sheets are heated, formed into a desired shape, and annealed in, for example, a lehr. FIGS. 1 and 2 illustrate successive steps in a prior art glass panel fabrication process and, in particular, a prior art glass shaping process. In FIG. 1, a glass sheet 10, which is to be formed into a desired shape for, for example, a vehicle windshield, is positioned between an upper press 12 and a lower press, or press ring, 14. As illustrated in FIG. 2, either the upper press 12, the lower press ring 14, or both the upper press 12 and the lower press ring 14 are moved so that the glass sheet 10 is formed to its desired shape due to the forces exerted on the glass sheet 10 by the upper press 12 and the lower press ring 14. The lower press ring 14 may be either a ring that contacts the perimeter of the glass sheet 10 or a mold that contacts all or a substantial portion of the glass sheet 10.

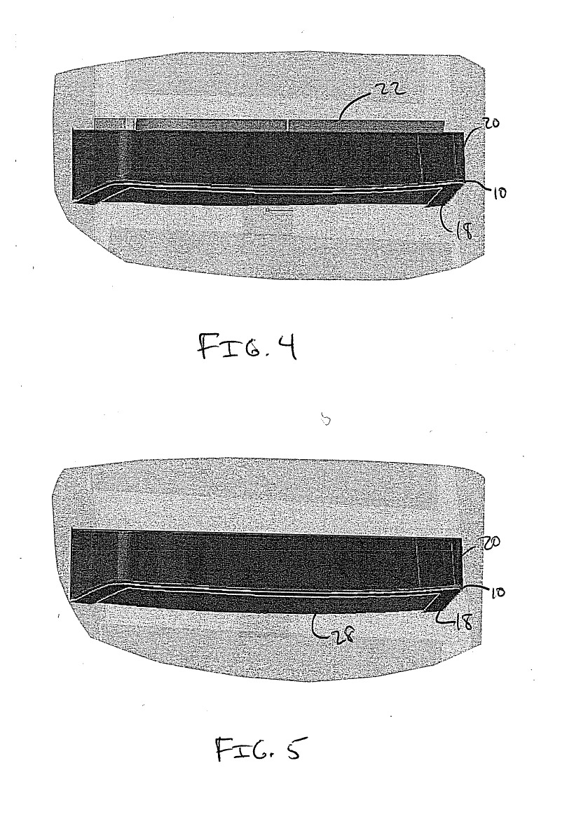

FIGS. 3-5 illustrate successive steps in a glass panel fabrication process in accordance with various embodiments of the present invention. As shown in FIGS. 3-5, a glass panel, such as a vehicle windshield, is formed into a desired shape using a multi-stage pressing process. As illustrated in FIG. 3, the glass sheet 10 is positioned between a lower press ring 18 and an upper press ring 20. An upper press 22, positioned within the upper press ring 20, is in a retracted position in which its lower surface 28 is located above the bottom face of the upper press ring 20. As illustrated in FIG. 4, in various embodiments either the upper press ring 20, the lower press ring 18, or both the upper press ring 20 and the lower press ring 18 are moved toward each other so that the glass sheet 10 is brought into contact with an upper surface 24 of the lower press ring 18 and a lower surface 26 of the upper press ring 20. The glass sheet 10 is thus clamped in place by the lower press ring 18 and the upper press ring 20. The perimeter of the glass sheet 10 is formed into the desired shape as defined by the shape of the lower press ring 18 and the upper press ring 20 when the press rings 18, 20 clamp the perimeter of the glass sheet 10. However, the area inside of the perimeter of the glass sheet 10, including the portion in the middle of the glass sheet 10, is not formed into its desired shape by such clamping.

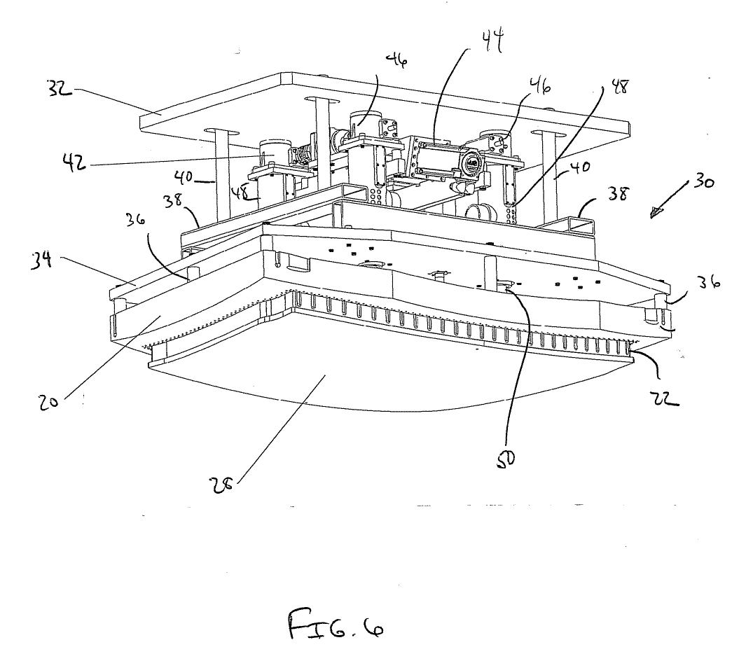

As illustrated in FIG. 5, after the glass sheet 10 is clamped into place by the press rings 18, 20, the upper press 22 is actuated in a downward direction within the upper press ring 20 such that an area inside of the perimeter of the glass sheet 10 (e.g., a middle area) is formed in the shape of the lower surface 28 (as seen through the glass sheet 10 in FIG. 5) of the upper press 22. It can be understood that the upper press 22 may be disposed in the upper press ring in any suitable manner and in one embodiment may be coaxially located within the upper press ring 20. The press rings 18, 20 and the upper press 22 may be constructed of, for example, billet steel, cast iron, ceramic, or any combination of the aforementioned materials. It can be understood that protective cloths (not shown) may be employed to protect the surface of the glass sheet 10 from the various surfaces of the press rings 18, 20 and the upper press 22. Such cloths may be constructed of, for example, stainless steel or a stainless steel/fiber cloth composite.

The process illustrated in FIGS. 3-5 has the advantage that it produces lower perimeter strain on the glass sheet 10 and thus perimeter distortion is reduced. Also, the process results in a lower and more evenly distributed strain on the glass sheet 10 during forming.

FIG. 6 illustrates a perspective view of a glass press assembly 30 that incorporates various elements of FIGS. 3-5 according to various embodiments of the present invention. As illustrated in FIG. 6, the assembly 30 is fixed in place with a mounting plate 32. The mounting plate 32 rigidly affixes the assembly 30 to, for example, a structural element of a tool on which the assembly 30 is mounted or a structural or mounting element of a building in which the assembly is housed. A lower plate 34 is attached to the upper press ring 20 via supports 36. The lower plate 34 is in turn attached, via a frame 38 and supports 40, to the mounting plate 32. An upper press positioning assembly 42 operates to raise and lower the upper press 22 within the upper press ring 20. The assembly 42 includes a reversible power source 44, such as a motor, that actuates piston assemblies 46. In various embodiments, the power source 44 may include an electric servo motor that incorporates a ball screw drive mechanism, an air cylinder, or any other type of hydraulically drive, cam driven, or air driven power source. Piston housings 48 of the piston assemblies 46 are each attached at one end to the mounting plate 32 and at the other end to the lower plate 34. Piston rods 50 that extend downward from the housings 48 of each of the piston assemblies 46 are attached to a top surface 52 of the upper press 22. Actuation of the piston assemblies 46 thus causes the upper press 22 to raise and lower within the confines of the upper press ring 20.

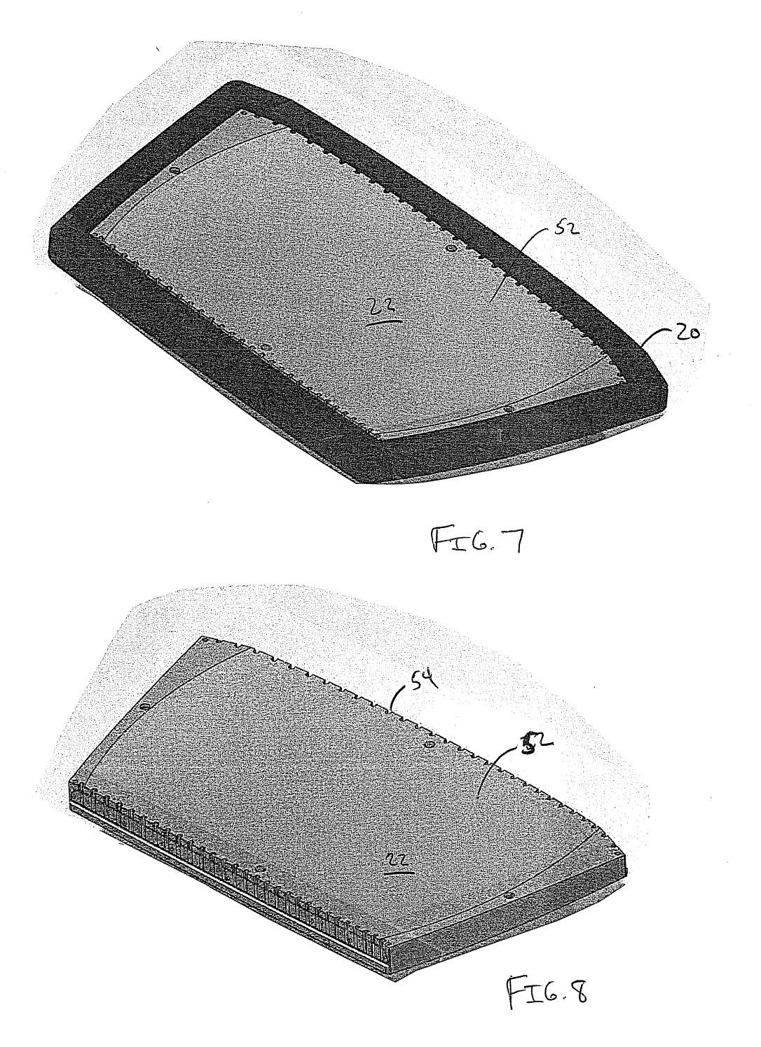

FIG. 7 illustrates a top perspective view of the upper press ring 20 and the upper press 22 according to various embodiments of the present invention. FIG. 8 illustrates a top perspective view of the upper press 22, as removed from the upper press ring 20, according to various embodiments of the present invention. As illustrated in FIG. 8, the upper press 22 may include a plurality of notches 54 that align with a plurality of protrusions (not shown) located on an inside surface of the upper press ring 20 so that the upper press ring remains in alignment during operation.

Embodiments of the present invention are directed to a process of forming glass sheets into a desired shape. The process may be used on glass sheets that are heated to a relatively low temperature without compromising the effectiveness of the process. Embodiments of the process and apparatus disclosed herein allow for a reduction in distortion of the formed glass and allow relatively complex shapes to be formed out of glass sheets. It can be understood that the process and apparatus disclosed herein may be used with or without the aid of a vacuum device used in the glass forming process. It can be understood that, although embodiments of the present invention are described herein as including two steps in the glass forming process (i.e., perimeter forming and center forming), any number of steps may be used as part of a multi-stage process to form a glass sheet into a desired shape. For example, after the perimeter of the glass sheet is clamped (i.e., formed), multiple upper presses may be used to form various portions of the glass sheet into a desired shape.

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention.

What is claimed is:

1. An apparatus for shaping at least one glass sheet, the apparatus comprising:
a lower press ring;
an upper press ring configured to clamp a perimeter section of the glass sheet between the lower press ring and the upper press ring; and
an upper press at least partially disposed within the upper press ring, the upper press configured to shape at least a section of the glass sheet inside the perimeter section of the glass sheet.

2. The apparatus of claim 1, wherein the upper press is radially disposed within the upper press ring.

3. The apparatus of claim 1, further comprising a power source that is configured to actuate movement of the upper press within the upper press ring.

4. The apparatus of claim 3, wherein the power source comprises an electric servo motor.

5. The apparatus of claim 1, further comprising a mounting plate configured to rigidly attach the upper press ring to a structural element.

6. A system for shaping at least one glass sheet, the system comprising:
a lower press ring;
an upper press assembly, the upper press assembly comprising:
an upper press ring configured to clamp a perimeter section of the glass sheet between the lower press ring and the upper press ring; and
an upper press at least partially disposed within the upper press ring, the upper press configured to shape at least a section of the glass sheet inside the perimeter section of the glass sheet; and
a press positioning assembly that is configured to raise and lower the upper press within the upper press ring.

7. The system of claim 6, further comprising a mounting plate configured to secure the upper press assembly to a structural element.

8. The system of claim 6, wherein the press positioning assembly comprises a power source.

9. The system of claim 8, wherein the power source comprises an electric servo motor.

10. The system of claim 6, wherein the press positioning assembly comprises at least one piston assembly.

11. An apparatus for shaping at least one glass sheet, the apparatus comprising:
means for clamping a perimeter section of the glass sheet; and
means for shaping at least a section of the glass sheet inside the perimeter section of the glass sheet.

12. The apparatus of claim 11, further comprising means for actuating movement of the means for shaping.

13. A method for shaping at least one glass sheet, the method comprising:
clamping a perimeter section of the glass sheet between a lower press ring and an upper press ring; and
shaping at least a section of the glass sheet inside the perimeter section of the glass sheet using a movable upper press that is disposed within the upper press ring.

14. The method of claim 13, wherein shaping includes moving the upper press toward the glass sheet until a desired shape of the glass sheet is obtained.

15. The method of claim 14, wherein shaping includes moving the upper press away from the glass sheet after a desired shape of the glass sheet is obtained.

16. The method of claim 13, further comprising heating the glass sheet.

17. The method of claim 13, further comprising annealing the glass sheet.
